(19) United States
(12) Patent Application Publication
(10) Pub. No.: US 2006/0003177 A1
(43) Pub. Date: Jan. 5, 2006

(54) Co-extruded mask layer

(75) Inventors: Dennis C. Smith, Norwalk, OH (US); Mark A. Tyler, West Salem, OH (US); Heather L. Scaglione, Brunswick, OH (US)

Correspondence Address: Michael R. Asam, Esq.;Jones Day, 901 Lakeside Avenue/North Point, Cleveland, OH, 44114, US

(73) Assignee: A. Schulman, Inc.

(21) Appl. No.: 11/170,205

(22) Filed: Jun. 29, 2005

Related U.S. Application Data
(60) Provisional application No. 60/585,415, filed on Jul. 2, 2004.

(51) Int. Cl. B32B 27/08; B32B 27/20

(52) U.S. Cl. 428/500; 428/515

(57) ABSTRACT

Co-extruded multilayer sheets that include a mask layer and a polymer layer are described. The mask layer exhibits a low level of adhesion with the polymer layer so it can be removed. The mask layer can adhere to the polymer layer during thermoforming and other secondary processing steps. The multilayer sheets can include any number of additional layers.

### RELATED APPLICATIONS

This application claims priority to U.S. Provisional Application Ser. No. 60/585,415, filed Jul. 2, 2004, which is hereby incorporated by reference.

### FIELD

Protective mask layers used to protect polymer surfaces from damage during processing, transport, etc.

### BACKGROUND

Laminated mask layers are sometimes applied to polymer sheet surfaces to protect the polymer sheet surfaces. The mask layers often employ adhesives to attach to the polymer sheet surfaces. The lamination process can leave a thin spacing creating voids or air bubbles between the polymer sheet surface and the mask layer. These can cause variations in the surface properties of the polymer sheet surface, e.g., variations in gloss or distinction of image. Additionally, contaminants can be introduced between the polymer surface and mask layer that can cause additional surface variations.

### SUMMARY

A multilayer sheet includes a mask layer and a polymer layer. The mask layer is co-extruded with the polymer layer and the mask layer exhibits a low level of adhesion with the polymer layer. The mask layer can adhere to the polymer layer during thermoforming and other secondary processing steps. The mask layer also does not degrade the surface of the polymer layer and can act as a moisture barrier. Multilayer sheets can include any number of additional layers.

### BRIEF DESCRIPTION OF THE DRAWINGS

FIG. 1 is a cross-sectional view of a two-layer sheet.

FIG. 2 is a cross-sectional view of a two-layer sheet where the top layer is partially separated.

FIG. 3 is a cross-sectional view of a three-layer sheet.

FIG. 4 is a cross-sectional view of a three-layer sheet where the top layer is partially separated.

### DETAILED DESCRIPTION

As examples of how a person of ordinary skill in the art can make and use the claimed invention, this description presents examples of multilayer sheets with co-extruded mask layers. These are described here to meet the requirements of enablement and best mode without imposing limitations that are not recited in the claims.

Each mask layer protects the surface of the next underlying layer of the multilayer sheet, but does not exhibit a cohesive level of adhesion with the underlying layer. Specifically, the mask layer can be peeled away from the underlying layer. The level of adhesion between the mask layer and the underlying layer can be sufficient, however, to retain the mask layer in place on a multilayer polymer film or sheet upon thermoforming or other secondary processing steps if such processing is intended. If required for the end product, the mask layer can be chosen such that it will not degrade the surface or diminish the surface quality of the underlying layer beyond a predetermined acceptable level.

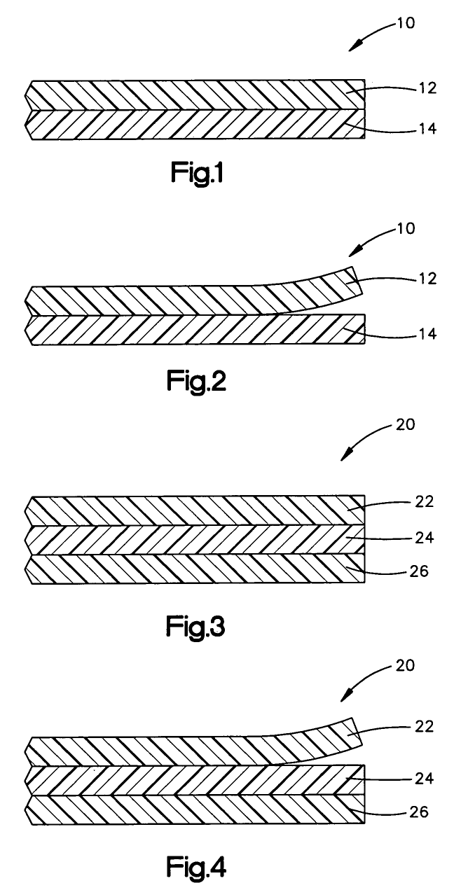

As shown in FIG. 1, a two-layer sheet 10 including a mask layer 12 and a polymer layer 14 can be formed by co-extrusion. Co-extrusion techniques are well known. Generally, co-extrusion of films or sheets refers to the process of extruding multiple polymer films in a co-planar arrangement such that the individual layers contact each other while the polymer films are still in a molten state. If the molecular structures of the individual polymer layers will interact, these interactions often occur while the polymers are in the molten state. Interactions between polymer layers can include, but are not intended to be limited to, physical interactions such as the intertwining of polymer chains between polymer layers, covalent bonding such as cross-linking of polymer chains between polymer layers, and ionic and other electrostatic interactions. Such interlayer interactions, for example, can create adhesion between the layers. Adhesion as used herein refers to the attractive forces exerted between two layers of a multilayer sheet. The level of adhesion can vary from high levels where the layers cannot be separated, to lower levels of adhesion where the layers can be separated upon the application of some force, to no adhesion between layers in which case the layers are free to move relative to each other.

The material of the mask layer 12 of FIG. 1 is selected so that the mask layer 12 will exhibit a low level of adhesion with the coextruded polymer layer 14. In other words, the mask layer 12 and polymer layer 14 interact with each other at a low level such that the mask layer 12 and polymer layer 14 can be separated upon the application of a force that is less than the tear strength of the mask layer 12. FIG. 2 shows a multilayer film with the mask layer 12 partially separated from the polymer layer 14. For example, the force required to remove the mask layer 12 from the polymer layer 14 can be between about 0.05 lbs./inch and about 8 lbs./inch. Alternatively, the force required to remove the mask layer 12 from the polymer layer 14 can be between about 0.05 lbs./inch and about 6 lbs./inch, between about 0.05 lbs./inch and about 4 lbs./inch, between about 0.05 lbs./inch and about 2 lbs./inch, or between about 0.05 lbs./inch and about 1 lb./inch. The level of adhesion can be low enough that the surface of the polymer layer 14 is not degraded by either the adhesion itself or the process of removing the mask layer 12 from the polymer layer 14. As used herein the term degrade is intended to mean to mar or distort the surface of the underlying layer. The term distort is intended to mean to cause variation in gloss or distinction of image. The exact level of adhesion that will degrade the surface of the polymer layer 14 will depend on the physical properties of the polymer used to form the polymer layer 14.

The thickness and flexibility of the mask layer 12 can impact the ease with which the mask layer 12 can be removed from the polymer layer. Generally for a given material the thicker the mask layer 12 the greater the degree of structural integrity the layer will have which could impact the ability to peel or remove it from the polymer layer 14. Additionally, the flexibility of the material used for the mask layer 12 in combination with the thickness could also impact the ability to peel or remove it from the polymer layer 14. Examples of materials that can be used to form the mask layer 12 include, but are not limited to, linear low density polyethylene, low density polyethylene, polyethylen-octene, polyethylene-hexene, polyethylene-butene, polypropylene, polyamides, polycarbonate, ABS, SEBS, TPE, cross linked thermoplastic vulcanizates, and copolymers and mixtures thereof. These materials can also include various additives to improve their performance. An example of the thickness of a mask layer 12 when a polyamide is used for the mask layer 12 is between about 25 and about 75 micrometers.

The choice of a material used to form a mask layer 12 depends on the material used for the polymer layer 14. As discussed above, the molecular interactions between the mask layer 12 and the polymer layer 14 are what determine whether the mask layer 12 will exhibit a low level of adhesion with the polymer layer 14. Therefore, the polymer used to create the mask layer 12 will be selected after the polymer used for the polymer layer 14 has been selected. For example, the polymer layer 14 could be, but is not intended to be limited to, an ionomer. A useful ionomer could be, but is not limited to, a copolymer of ethylene and an α,β-ethenically unsaturated C₃-C₈ carboxylic acid that is partially neutralized with zinc, sodium, magnesium, or lithium ions. An example of a polymer that could be used for the mask layer 12 when a copolymer of ethylene and an α,β-ethenically unsaturated C₃-C₈ carboxylic acid is used for the polymer layer is a polyamide.

The gloss level of the surface of the polymer layer 14 after the mask layer 12 has been removed can be a consideration in deciding a combination of materials to use for the mask layer 12 and the polymer layer 14. Gloss in this case refers to the “shininess” of the surface of the polymer layer 14 after the mask layer 12 has been removed. More specifically, the gloss of a surface can be described as the reflection of light from the surface (independent of color). To measure the gloss of a surface, a single beam of light at a specific angle can be deflected off the surface onto a detector. The detector then measures the intensity of the light received. A controller and display unit connected to the detector can then either provide an intensity value that can be converted into a gloss value or the controller can directly display a gloss value. The higher the gloss value, the shinier the surface.

A standardized test method for gloss is ASTM D 523. The standard angle of the single beam of light in ASTM D 523 is 60°, but angles of 20° and 85° are also used for specific situations. For the multilayer sheets described herein, if a high gloss is required for the polymer layer 14 when the mask layer 12 has been removed, then a gloss level of greater than about 85 as measured at 60° could be specified. Alternatively, a gloss level for the polymer layer 14 when the mask layer 12 has been removed of greater than about 90, greater than about 95, or greater than about 100 as measured at 60° could be specified.

The multilayer sheets can have any number of additional layers. The additional layers could perform various functions including providing color or structural rigidity. FIG. 3 shows an example of a three-layer sheet. In FIG. 3, the three-layer sheet 20 comprises a mask layer 22, a clear ionomer layer 24, and a polymer layer 26. The mask layer 22 and the polymer layer 26 have the same properties as the mask layer 12 and polymer layer 14 described above. The clear ionomer layer 24 is simply an ionomer layer as described above with no pigment added. The multilayer sheets could also include an additional backing layer or layers. These backing layers could be, but are not limited to, polypropylenes, TPO, polyethylenes, polyamides, polyesters, acrylonitrile butadiene styrene, and copolymers and mixtures thereof.

The multilayer sheets with a mask layer can be thermoformed, for example to form an automobile bumper, or subjected to other secondary processing steps. If a multilayer sheet with a mask layer is to be thermoformed or subjected to other secondary processing steps, the mask layer can be chosen such that the mask layer will adhere to the underlying polymer layer during the thermoforming or secondary processing step. The presence of a mask layer during these steps will help protect the surface of the underlying polymer layer. The force required to remove a mask layer that will adhere to an underlying polymer layer during thermoforming is between about 0.05 lbs./inch and about 8 lbs./inch. Alternatively, the force required to remove a mask layer that will adhere to an underlying polymer layer during thermoforming can be between about 0.05 lbs./inch and about 6 lbs./inch, between about 0.05 lbs./inch and about 4 lbs./inch, between about 0.05 lbs./inch and about 2 lbs./inch, or between about 0.05 lbs./inch and about 1 lb./inch. Even if the multilayer sheet is not thermoformed or subjected to other secondary processing steps, the presence of a mask layer will help protect the surface of the underlying polymer layer during shipping or handling of the multilayer sheet.

The mask layer of the multilayer sheets described herein can act as a moisture barrier for the underlying polymer layer. Some polymers can absorb moisture either from direct contact with water or from ambient atmospheric humidity. Often, when thermoforming or performing secondary processing steps on a given polymer product it is necessary to dry the polymer product. If the polymer product is not dried prior to thermoforming or performing secondary processing steps, any water absorbed into the polymer product will be released during the thermoforming or performing secondary processing steps potentially causing distortion of the appearance of the sheet. As an example, ionomer materials are hygroscopic at different levels depending on the ion used to neutralize the ionomer (different ions absorb moisture at different rates). Thus, when an ionomer material is used for an underlying polymer layer of a multilayer sheet, the mask layer, if an appropriate material is chosen, can act as a moisture barrier which could allow the mulitlayer sheet to be processed without drying first.

This written description sets forth the best mode of the invention, and describes the invention so as to enable a person skilled in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they include equivalent elements with insubstantial differences from the literal language of the claims.

What is claimed is:

1. A coextruded multilayer sheet comprising:
a polymer layer; and
the mask layer co-extruded polymer layer and having a low level of adhesion with the polymer layer.

2. The multilayer sheet of claim 1, wherein the mask layer does not degrade the surface of the polymer layer.

3. The multilayer sheet of claim 1, wherein the polymer layer has a gloss level of greater than about 85 as measured at 60° when the mask layer is removed.

4. The multilayer sheet of claim 1, wherein the mask layer acts as a moisture barrier.

5. The multilayer sheet of claim 1, wherein the force required to remove the mask layer is between about 0.05 lbs./inch and about 8 lbs./inch.

6. The multilayer sheet of claim 1, wherein the force required to remove the mask layer is between about 0.05 lbs./inch and about 4 lbs./inch.

7. The multilayer sheet of claim 1, wherein the force required to remove the mask layer is between about 0.05 lbs./inch and about 2 lbs./inch.

8. The multilayer sheet of claim 1, wherein the polymer layer comprises an ionomer.

9. A coextruded multilayer sheet comprising:
a polymer layer;
a clear ionomer layer; and
a mask layer coextruded with the clear ionomer layer and the polymer layer having a low level of adhesion with the clear ionomer layer.

10. The multilayer film or sheet of claim 9, wherein the mask layer does not degrade the surface of the clear ionomer layer.

11. The multilayer film or sheet of claim 9, wherein the clear ionomer layer maintains a gloss level of greater than about 85 as measured at 60° when the mask layer is removed.

12. The multilayer film or sheet of claim 9, wherein the mask layer acts as a moisture barrier.

13. The multilayer film or sheet of claim 9, wherein the force required to remove the mask layer is between about 0.05 lbs./inch and about 8 lbs./inch.

14. The multilayer film or sheet of claim 9, wherein the force required to remove the mask layer is between about 0.05 lbs./inch and about 4 lbs./inch.

15. The multilayer film or sheet of claim 9, wherein the force required to remove the mask layer is between about 0.05 lbs./inch and about 2 lbs./inch.

16. The multilayer film or sheet of claim 9, wherein the polymer layer is pigmented.

17. The multilayer film or sheet of claim 9, wherein the polymer layer comprises an ionomer.

18. A coextruded multilayer sheet comprising:
a pigmented ionomer layer;
a clear ionomer layer; and
a mask layer coextruded with the clear ionomer layer and the polymer layer having a level of adhesion with the clear ionomer layer such that the force required to remove the mask layer is between about 0.05 lbs./inch and about 8 lbs./inch and the mask layer acts as a moisture barrier.

19. The multilayer film or sheet of claim 18, wherein the mask layer does not degrade the surface of the clear ionomer layer.

20. The multilayer film or sheet of claim 18, wherein the clear ionomer layer maintains a gloss level of greater than about 85 as measured at 60° when the mask layer is removed.
